(19) United States
(12) Patent Application Publication
(10) Pub. No.: US 2011/0054726 A1
(43) Pub. Date: Mar. 3, 2011

(54) DRIVING FORCE CONTROL APPARATUS FOR VEHICLE AND DRIVING FORCE CONTROL METHOD FOR VEHICLE

(75) Inventor: Shin Noumura, Aichi-ken (JP)

(73) Assignee: TOYOTA JIDOSHA KABUSHIKI KAISHA, Toyota-shi, Aichi-ken (JP)

(21) Appl. No.: 12/934,212

(22) PCT Filed: Mar. 27, 2009
(86) PCT No.: PCT/IB2009/005090

§ 371 Date: Sep. 23, 2010

(30) Foreign Application Priority Data
Mar. 28, 2008 (JP) 2008-087088

(51) Int. Cl. B60L 15/20

(52) U.S. Cl. 701/22

(57) ABSTRACT

An ECU (30) includes a target driving force calculating unit (31) and an alternator target driving force correcting unit (33). The target driving force calculating unit (31) calculates an alternator target driving force Fx_ac when an alternator (20) is used for controlling a driving force of a vehicle. The alternator target driving force correcting unit (33) corrects the alternator target driving force Fx_ac, which is calculated by the target driving force calculating unit (31), by adding a charging driving force Fx_dc that is used when the alternator (20) charges a battery (40) with a target battery voltage to determine an ultimate alternator target driving force Fx_total.

### BACKGROUND OF THE INVENTION

1. Field of the Invention

The invention relates to a driving force control apparatus for a vehicle and a driving force control method for a vehicle and, more specifically, to a driving force control apparatus for a vehicle and a driving force control method for a vehicle, which use an alternator for controlling a driving force of the vehicle.

2. Description of the Related Art

Generally, an engine torque is controlled using a throttle opening degree (intake air amount) and/or a fuel injection amount. A delay in response of an intake system (delay in time until air that has passed through a throttle valve is taken in into a cylinder) occurs by the time when a change in throttle opening degree (variation in the amount of air passing through a throttle) appears as a variation in engine torque (variation in the amount of air that fills the cylinder).

Japanese Patent Application Publication. No. 2007-9885 (JP-A-2007-9885) describes a technique for correcting an engine torque using an alternator torque. In an engine driving force apparatus described in JP-A-2007-9885, when an accelerator pedal is rapidly returned to cause a jerk, in order to control an actual output torque toward a target torque, a load of an alternator driven by an output shaft of an engine is configured to be variable and then a positive unnecessary torque due to the jerk is cancelled by increasing a load on the engine.

In the engine driving force apparatus described in JP-A-2007-9885, the alternator is used for charging a battery; however, when the alternator is used for applications other than electric power generation, there is a problem that a battery voltage fluctuates. In addition, it is necessary to ensure electric power for driving a plurality of auxiliary machines during vehicle running. When the alternator is used for applications other than ensuring electric power for those machines, there is a problem that necessary electric power may not be ensured or the alternator may actively operate to cause an overvoltage.

### SUMMARY OF THE INVENTION

The invention provides a driving force control apparatus for a vehicle and a driving force control method for a vehicle, which are able to control a driving force of the vehicle using an alternator while ensuring necessary electric power used in the vehicle.

A first aspect of the invention provides a driving force control apparatus for a vehicle. The driving force control apparatus controls a driving force of the vehicle by controlling a driving force generating source and an alternator that is driven by the driving force generating source and that charges a battery. The driving force control apparatus includes: a target driving force calculating unit that calculates an alternator target driving force when the alternator is used for controlling the driving force of the vehicle; and an alternator target driving force correcting unit that corrects the alternator target driving force, which is calculated by the target driving force calculating unit, using a charging driving force that is used when the alternator charges the battery with a target battery voltage to determine an ultimate alternator target driving force.

The alternator target driving force correcting unit may correct the alternator target driving force, which is calculated by the target driving force calculating unit, on the basis of a battery voltage or state of charge of the battery.

The alternator target driving force correcting unit may correct the alternator target driving force, which is calculated by the target driving force calculating unit, on the basis of a driving force sign of the alternator target driving force.

When a driving force sign of the alternator target driving force calculated by the target driving force calculating unit is positive and when the battery voltage or the state of charge is low, the alternator target driving force correcting unit may multiply the alternator target driving force by a control gain smaller than that when the battery voltage or the state of charge is high.

When a driving force sign of the alternator target driving force calculated by the target driving force calculating unit is negative and when the battery voltage or the state of charge is low, the alternator target driving force correcting unit may multiply the alternator target driving force by a control gain larger than that when the battery voltage or the state of charge is high.

The alternator target driving force correcting unit may determine the ultimate alternator target driving force between a first threshold and a second threshold that is smaller than the first threshold.

When a driving force sign of the alternator target driving force calculated by the target driving force calculating unit is positive and when the battery voltage or the state of charge is closer to a second reference value corresponding to the second threshold than to a first reference value corresponding to the first threshold, the alternator target driving force correcting unit may multiply the alternator target driving force by a control gain smaller than that when the battery voltage or the state of charge is closer to the first reference value than to the second reference value.

When a driving force sign of the alternator target driving force calculated by the target driving force calculating unit is negative and when the battery voltage or the state of charge is closer to a second reference value corresponding to the second threshold than to a first reference value corresponding to the first threshold, the alternator target driving force correcting unit may multiply the alternator target driving force by a control gain larger than that when the battery voltage or the state of charge is closer to the first reference value than to the second reference value.

When a driving force sign of the alternator target driving force calculated by the target driving force calculating unit is both positive and negative or unknown and when the battery voltage or the state of charge is middle between a first reference value corresponding to the first threshold and a second reference value corresponding to the second threshold, the alternator target driving force correcting unit may multiply the alternator target driving force by a control gain larger than that when the battery voltage or the state of charge is close to the first reference value or to the second reference value.

A second aspect of the invention provides a driving force control method for a vehicle. The driving force control method controls a driving force of the vehicle by controlling a driving force generating source and an alternator that is driven by the driving force generating source and that charges a battery. The driving force control method includes: determining an alternator target driving force when the alternator is used for controlling the driving force of the vehicle; and correcting the alternator target driving force using a charging driving force that is used when the alternator charges the battery with a target battery voltage to determine an ultimate alternator target driving force.

With the driving force control apparatus for a vehicle and the driving force control method for a vehicle according to the aspects of the invention, which control a driving force of the vehicle by controlling a driving force generating source and an alternator that is driven by the driving force generating source and that charges a battery, an alternator target driving force is determined when the alternator is used for controlling the driving force of the vehicle, and the determined alternator target driving force is corrected using a charging driving force that is used when the alternator charges the battery with a target battery voltage to determine an ultimate alternator target driving force. Thus, it is advantageously possible to provide the driving force control apparatus for a vehicle and the driving force control method for a vehicle, which are able to control a driving force of the vehicle using the alternator while ensuring necessary electric power used in the vehicle.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a view that shows a configuration example of portion of a vehicle to which a driving force control apparatus for a vehicle according to the invention is applied;

FIG. 2 is a graph that shows an example of the characteristics in engine rotational speed versus time constant of an engine and an alternator;

FIG. 3 is a view that shows an example of a model of charging a battery;

FIG. 4 is a view that shows a functional configuration example of an alternator target driving force correcting unit;

FIG. 5 is a first flowchart that shows the operation flow of the alternator target driving force correcting unit when coordinated vehicle driving force control is executed; and

FIG. 6 is a second flowchart that shows the operation flow of the alternator target driving force correcting unit when the coordinated vehicle driving force control is executed.

### DETAILED DESCRIPTION OF EMBODIMENTS

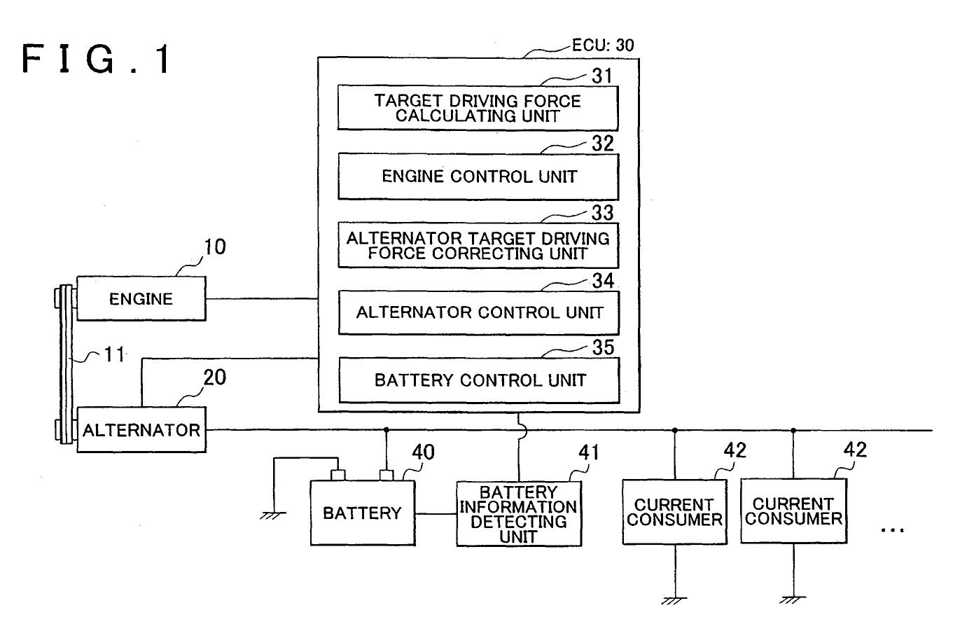

FIG. 1 is a view that shows a configuration example of portion of a vehicle to which a driving force control apparatus for a vehicle according to the invention is applied. In FIG. 1, an engine 10, which is a driving force generating source, is, for example, a gasoline engine having a plurality of cylinders. Air is taken in into a combustion chamber of each cylinder through an intake passage, and fuel injected from a fuel injection valve is supplied to each combustion chamber. When the mixture of fuel and air is ignited by an ignition plug, the air-fuel mixture burns to cause a piston to reciprocate, and then a crankshaft, which is an output shaft of the engine 10, rotates. Exhaust gas generated through burning of the air-fuel mixture is discharged from each combustion chamber to an exhaust passage.

Driving force (torque) of the engine 10 is adjusted in such a manner that a throttle valve provided in the intake passage is driven by a throttle actuator, such as a motor, to adjust the opening degree of the throttle valve (hereinafter, referred to as “throttle opening degree”). That is, an air intake amount into the engine is varied by adjusting the throttle opening degree, the fuel injection amount is controlled in response to the variation in air intake amount, and the amount of air-fuel mixture that fills each combustion chamber varies, thus adjusting the driving force of the engine 10. Note that the throttle opening degree is adjusted in such a manner that the throttle actuator is driven on the basis of the amount of depression of an accelerator pedal operated by a driver.

In addition, the vehicle is equipped with an alternator 20 and a battery 40 for supplying electric power to various current consumers 42. The alternator 20 is drivably coupled to the crankshaft of the engine 10 via a pulley, a transmission belt 11, and the like, and generates electric power as the engine 10 operates. Electric power generated by the alternator 20 is supplied to the battery 40 and the various current consumers 42.

The alternator 20 has a three-phase alternating current generator formed of a stator coil having a three-phase coil and a field coil located inside the stator coil. The alternator 20 generates induced electric power in the stator coil by rotating the field coil being supplied with electric current and converts induced electric current (three-phase alternating current) into direct current by a rectifier to charge the battery 40. In addition, the alternator 20 includes a voltage regulator. The alternator 20 controls a field electric current that flows through the field coil using the voltage regulator in accordance with a control signal input from an ECU 30 to adjust induced electric power generated in the stator coil, thus controlling the amount of electric power generation.

The battery 40 is an electric storage device and is formed of a secondary battery (of, for example, 14 V). A battery information detecting unit 41 detects battery information related to the battery 40 (battery temperature, battery current, battery voltage, state of charge (SOC), or the like) and outputs the battery information to the ECU 30.

In addition, the vehicle is equipped with the electronic control unit (ECU) 30 that controls various portions, such as the engine 10. The ECU 30 includes an input/output device, a ROM that stores control maps, control data, control programs, and the like, a RAM that temporarily stores a processing result, or the like, a central processing unit (CPU), an ND converter, a D/A converter, a communication driver circuit, and the like. The CPU uses the RAM as a working area to execute various controls in accordance with the control programs, control maps, control data, and the like, stored in the ROM. In addition, as the CPU executes the control programs, the ECU 30 functions as a target driving force calculating unit 31, an engine control unit 32, an alternator target driving force correcting unit 33, an alternator control unit 34 and a battery control unit 35.

When routine vehicle driving force control (=vehicle engine drive control) is executed, the target driving force calculating unit 31 calculates an engine target driving force Fx_ec on the basis of an operating state of the vehicle, and outputs the calculated engine target driving force Fx_ec to the engine control unit 32. The routine vehicle driving force control is, for example, executed at intermediate to high engine rotational speeds. In addition, when engine-alternator coordinated vehicle driving force control (hereinafter, referred to as “coordinated vehicle driving force control”) is executed, the target driving force calculating unit 31 calculates a vehicle target driving force on the basis of an operating state of the vehicle, and distributes the vehicle target driving force to an engine target driving force Fx_ec and an alternator target driving force Fx_ac. The target driving force calculating unit 31 outputs the engine target driving force Fx_ec to the engine control unit 32 and also outputs the alternator target driving force Fx_ac and its driving force sign to the alternator target driving force correcting unit 33. The coordinated vehicle drive control is, for example, executed at low to intermediate engine rotational speeds.

The engine control unit 32 controls the throttle opening degree, or the like, of the engine 10 so as to attain the engine target driving force Fx_ec calculated by the target driving force calculating unit 31.

When the coordinated vehicle driving force control is executed, the alternator target driving force correcting unit 33 corrects the alternator target driving force Fx_ac calculated by the target driving force calculating unit 31 on the basis of a current battery voltage and also corrects the alternator target driving force Fx_ac using a charging driving force Fx_dc that is used when the alternator 20 charges the battery 40 with a target battery voltage to determine an ultimate alternator target driving force Fx_total, and then outputs the ultimate alternator target driving force Fx_total to the alternator control unit 34.

The alternator control unit 34 calculates a deviation ΔV between the current battery voltage and the target battery voltage, and controls the voltage regulator of the alternator 20 on the basis of the deviation ΔV to control the amount of electric power generated by the alternator 20. In addition, when the coordinated vehicle driving force control is executed, the alternator control unit 34 controls the voltage regulator of the alternator 20 on the basis of the ultimate alternator target driving force determined by the alternator target driving force correcting unit 33 to control the amount of electric power generated by the alternator 20.

The battery control unit 35 calculates a target battery voltage on the basis of the battery information related to the battery 40 (battery temperature, battery current, battery voltage, state of charge (SOC), and the like), input from the battery information detecting unit 41.

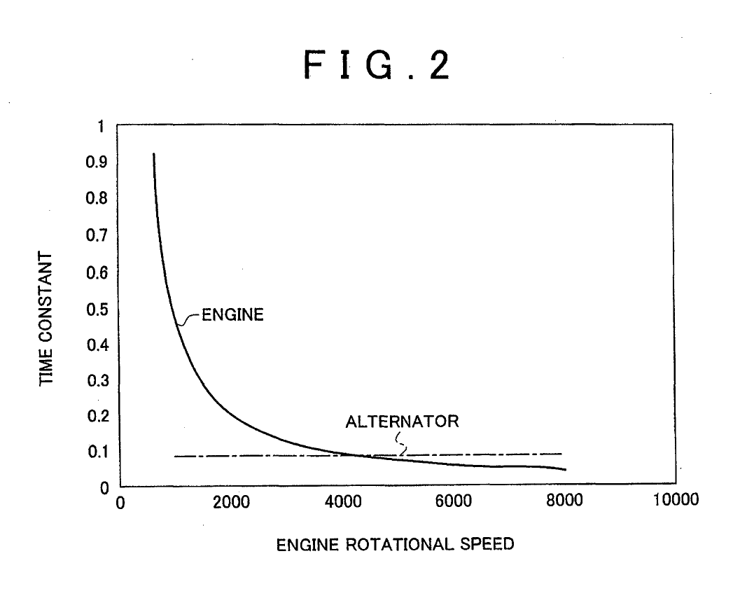

Next, the coordinated vehicle driving force control will be described in detail. FIG. 2 is a graph that shows an example of the characteristics in engine rotational speed versus time constant of the engine 10 and the alternator 20. The engine 10 has a large time constant at low engine rotational speeds, whereas the alternator 20 has a small time constant at low to high engine rotational speeds. When vehicle driving force control is executed through the throttle opening degree of the engine 10, generally; a delay in accordance with an engine rotational speed as shown in the graph occurs in intake stroke. On the other hand, when vehicle driving force control is executed by the alternator 20, a delay occurs because of the reactance of the field coil; however, generally, it is more responsive at low engine rotational speeds than an engine throttle control. For this reason, the alternator 20 is actively used in vehicle driving force control at low to intermediate engine rotational speeds. Thus, in comparison with a vehicle driving force control using engine throttle only, a highly responsive vehicle driving force control is possible. Then, in the present embodiment, the coordinated vehicle driving force control that controls both an engine driving force and an alternator driving force is executed at low to intermediate engine rotational speeds to enable highly responsive vehicle driving force control.

However, as described above, the alternator 20 is used for charging the battery 40. When the alternator 20 is used for applications of a vehicle drive control, other than electric power generation, necessary electric power used in the vehicle may not be ensured. In the present embodiment, in the coordinated vehicle driving force control, the generating capacity of the alternator 20 is considered separately into a portion for controlling a battery voltage (charging driving force Fx_dc) and a portion for controlling a vehicle driving force (alternator target driving force Fx_ac) to ensure necessary electric power used in the vehicle even when the alternator is used to generate a vehicle driving force.

In addition, a driving force generated by the alternator 20 needs to be determined in consideration of a battery voltage and an SOC. If the battery voltage or the SOC is not taken into consideration, for example, the battery voltage fluctuates and does not fall within a desired range. This may adversely affects other electrical systems in the vehicle. In addition, frequency characteristic varies and, therefore, an expected advantageous effect may not be obtained from the vehicle drive control.

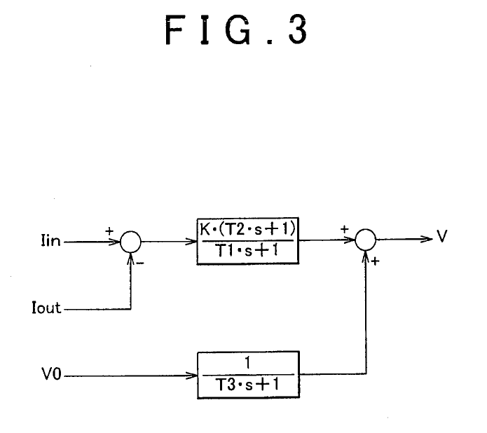

FIG. 3 is a view that shows an example of a model of charging the battery 40. In the drawing, Iin denotes alternator current, Iout denotes consumption current, V0 denotes alternator electromotive force, V denotes battery voltage, Tn denotes time constant, and s denotes Laplace operator. In the drawing, it is known that an increase in battery voltage V may be suppressed by decreasing the alternator electromotive force V0, that is, decreasing a driving force generated by the alternator 20. In the present embodiment, focusing on the characteristic that generating capacity is small when a positive driving force is generated by the alternator 20 and generating capacity is large when a negative driving force is generated by the alternator 20, vehicle driving force control is carried out while bringing the battery voltage and the SOC within a desired range to thereby prevent fluctuations in battery voltage.

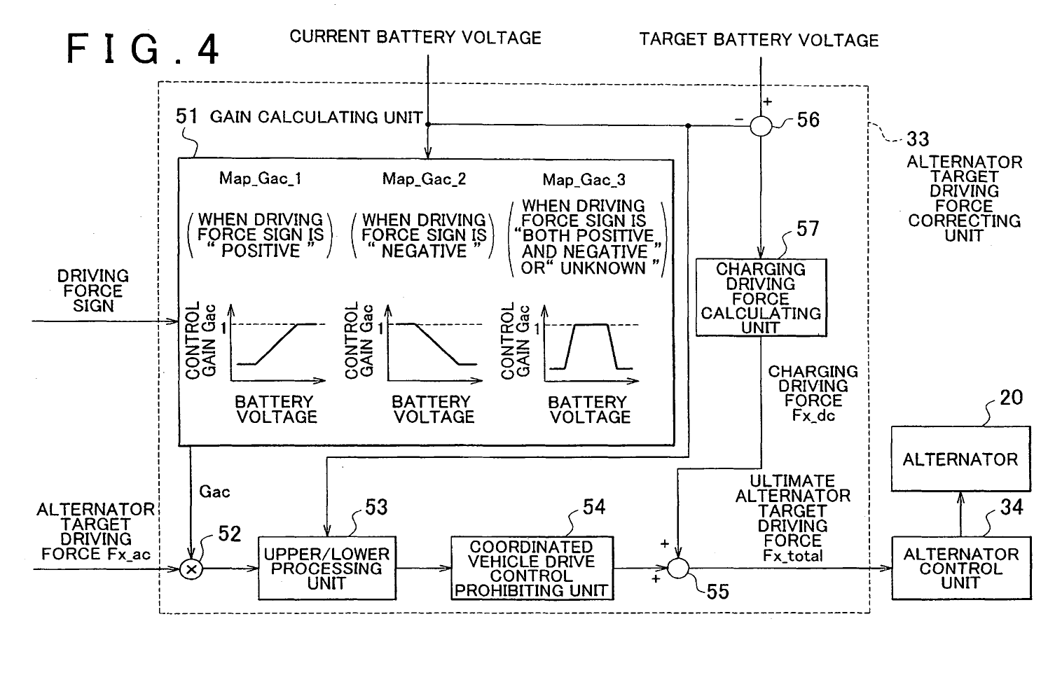

FIG. 4 is a functional configuration diagram of the alternator target driving force correcting unit 33. The alternator target driving force correcting unit 33 includes a gain calculating unit 51, a multiplication unit 52, an upper/lower limit processing unit 53, a coordinated vehicle drive control prohibiting unit 54, an adding unit 55, a subtracting unit 56, and a charging driving force calculating unit 57.

To the alternator target driving force correcting unit 33, an alternator target driving force (torque) Fx_ac and its driving force sign are input from the target driving force calculating unit 31, a current battery voltage is input from the battery information detecting unit 41 and a target battery voltage is input from the battery control unit 35.

The gain calculating unit 51 calculates a gain Gac on the basis of the driving force sign of the alternator target driving force Fx_ac and the current battery voltage, and outputs the calculated gain Gac to the multiplication unit 52. Here, the driving force sign is a driving force control amount by which the alternator 20 is actively operated, and includes four types, that is, positive, negative, both positive and negative, and unknown. When a positive driving force is generated by the alternator 20, the amount of electric power generation is small. When a negative driving force is generated by the alternator 20, the amount of electric power generation is large. The gain calculating unit 51 has gain maps Map_Gac_01 to Map_Gac_03 in which the relationship between a battery voltage and a gain Gac is stored in advance using the battery voltage as a variable.

The gain map Map_Gac_01 is used when the driving force sign is “positive”. The control gain Gac takes a small value when the battery voltage is low, and the control gain Gac takes a large value when the battery voltage is high. In addition, the gain map Map_Gac_02 is used when the driving force sign is “negative”. The control gain Gac takes a large value when the battery voltage is low, and the control gain Gac takes a small value when the battery voltage is high. The gain map Map_Gac_03 is used when the driving force sign is “both positive and negative” or “unknown”. The control gain Gac takes a small value when the battery voltage is low or high, and the control gain Gac takes a large value when the battery voltage is middle.

The gain calculating unit 51 selects any one of the gain maps Map_Gac_01 to Map_Gac_03 on the basis of the driving force sign of the alternator target driving force Fx_ac, calculates a control gain Gac corresponding to the current battery voltage by referring to the selected gain map, and then outputs the calculated control gain Gac to the multiplication unit 52.

The multiplication unit 52 multiplies the alternator target driving force Fx_ac by the control gain Gac and outputs the resultant value to the upper/lower limit processing unit 53. Thus, the alternator target driving force Fx_ac is corrected by the control gain Gac based on the driving force sign of the alternator target driving force Fx_ac and the current battery voltage. When the control gain Gac is small, a control amount at the charging side is large and a control amount at the discharging side is small. On the other hand, when the control gain Gac is large, a control amount at the charging side is small and a control amount at the discharging side is large.

When the battery voltage is larger than or equal to a threshold V1 (battery voltages≧threshold V1), the upper/lower limit processing unit 53 sets an upper limit value, that is, |alternator target driving force maximum value Fx_ac_max|=Fmax. In addition, when the battery voltage is smaller than or equal to a threshold V2 (battery voltages≦threshold V2) (where V1>V2), the upper/lower limit processing unit 53 sets a lower limit value, that is, |alternator target driving force minimum value Fx_ac_min|=Fmin. Thus, the upper/lower limit processing unit 53 sets upper/lower guards of the upper limit value and lower limit value for the alternator target driving force Fx_ac.

When the battery voltage does not fall within the range from V3 to a threshold V4 (V3≦5 battery voltage≦threshold V4), the coordinated vehicle drive control prohibiting unit 54 prohibits the coordinated vehicle driving force control and sets the alternator target driving force Fx_ac at 0.

The subtracting unit 56 calculates a deviation ΔV between the current battery voltage and the target battery voltage, and outputs the calculated deviation ΔV to the charging driving force calculating unit 57. The charging driving force calculating unit 57 calculates a charging driving force Fx_dc (which is obtained by converting the amount of electric power generation used in PID control into a driving force) used in PM control on the basis of the deviation ΔV between the target battery voltage and the current battery voltage, and outputs the calculated charging driving force Fx_dc to the adding unit 55.

The adding unit 55 adds the alternator target driving force Fx_ac and the charging driving force Fx_dc to calculate an ultimate alternator target driving force Fx_total, and outputs the calculated ultimate alternator target driving force Fx_total to the alternator control unit 34. In this way, by adding the charging driving force Fx_dc to the alternator target driving force Fx_ac, the amount of electric power generation necessary for charging the battery 20 may be ensured. The alternator control unit 34 controls a field current that flows through the field coil of the alternator 20 on the basis of the ultimate alternator target driving force Fx_total output from the alternator target driving force correcting unit 33 to control a driving force (amount of electric power generation) of the alternator 20.

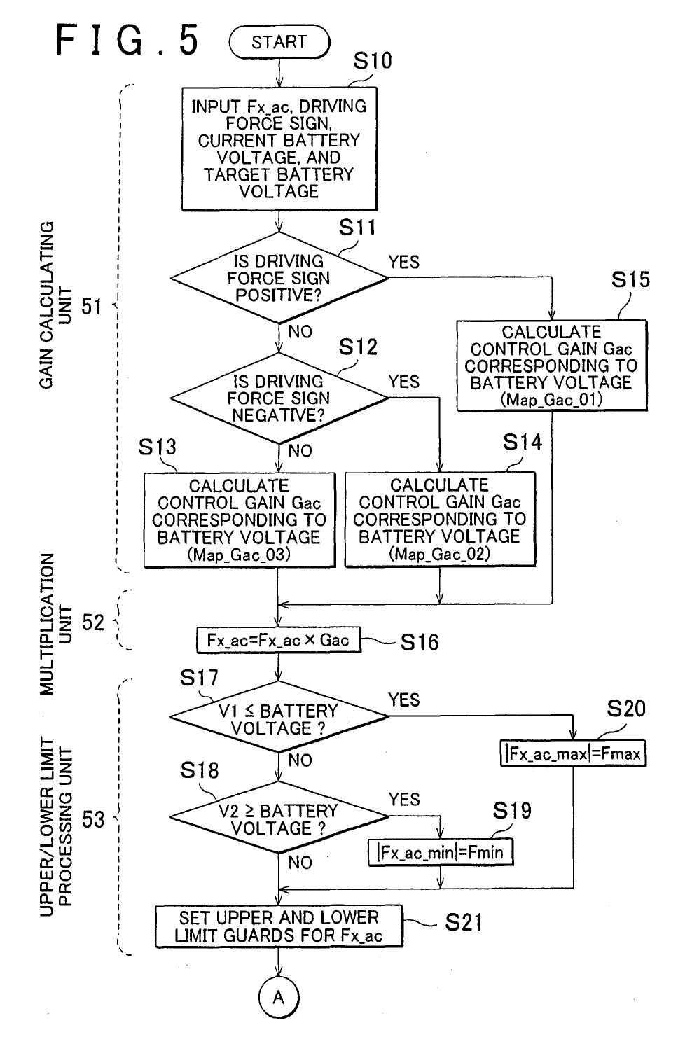

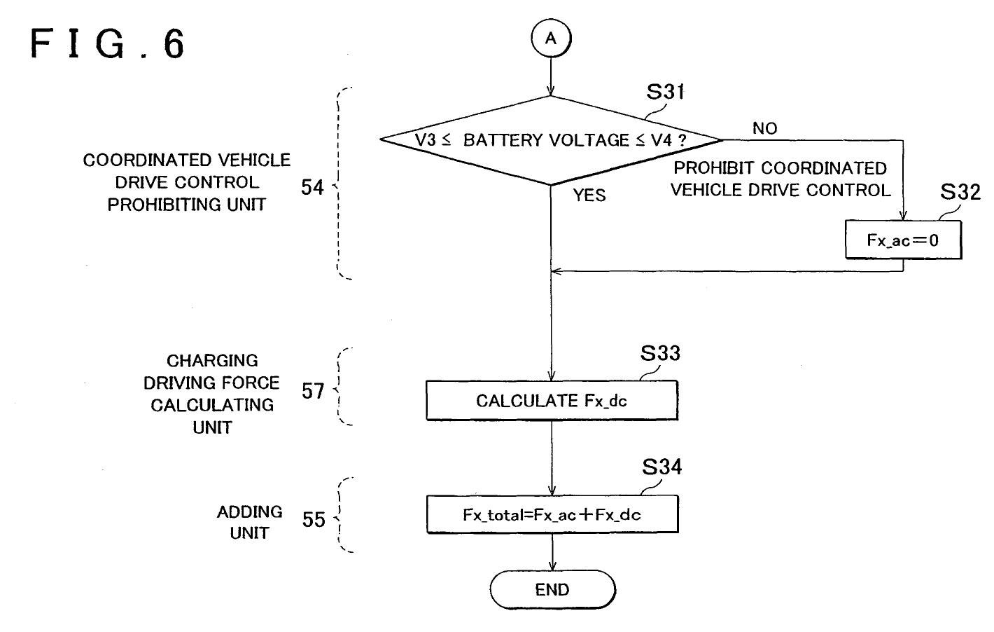

FIG. 5 and FIG. 6 show the operation flow of the alternator target driving force correcting unit 33 when the coordinated vehicle driving force control is executed. In FIG. 5, to the alternator target driving force correcting unit 33, an alternator target driving force Fx_ac and its driving force sign are input from the target driving force calculating unit 31, a current battery voltage is input from the battery information detecting unit 41 and a target battery voltage is input from the battery control unit 35 (step S10).

The gain calculating unit 51 determines whether the driving force sign is “positive” (step S11). When the driving force sign is “positive” (“Yes” in step S11), the gain calculating unit 51 refers to the gain map Map_Gac_01 and calculates a control gain Gac corresponding to the battery voltage (step S15).

When the driving force sign is not “positive” (“No” in step S11), the gain calculating unit 51 determines whether the driving force sign is “negative” (step S12). When the driving force sign is “negative” (“Yes” in step S11), the gain calculating unit 51 refers to the gain map Map_Gac_02 and calculates a control gain Gac corresponding to the battery voltage (step S14).

When the driving force sign is not “negative” (“No” in step S12), that is, when the driving force sign is “both positive and negative” or “unknown”, the gain calculating unit 51 refers to the gain map Map_Gac_03 and calculates a control gain Gac corresponding to the battery voltage (step S13).

In step S16, the multiplication unit 52 multiplies the alternator target driving force Fx_ac by the control gain Gac calculated in the above steps S13 to S14 to correct the alternator target driving force Fx_ac.

Subsequently, the upper/lower limit processing unit 53 determines whether the battery voltage V is larger than or equal to a threshold V1 (step S17). When the battery voltage V is larger than or equal to the threshold V1 (“Yes” in step S17), the upper/lower limit processing unit 53 sets alternator target driving force maximum value Fx_ac_max|=Fmax (step S20), and then the process proceeds to step S21. In addition, when the battery voltage is not larger than or equal to the threshold V1 (“No” in step S17), the upper/lower limit processing unit 53 determines whether the battery voltage is smaller than or equal to a threshold V2 (where V1>V2) (step S18). When the battery voltage is not smaller than or equal to the threshold V2 (“No” in step S18), the process proceeds to step S21, whereas, when the battery voltage is smaller than or equal to the threshold V2 (“Yes” in step S18), the upper/lower limit processing unit 53 sets |alternator target driving force minimum value Fx_ac_min|=Fmin (step S19).

In step S21, the upper/lower limit processing unit 53 sets the upper/lower guards of the |alternator target driving force maximum value Fx_ac_max| and |alternator target driving force minimum value Fx_ac_min| for the alternator target driving force Fx_ac.

Subsequently, in step S31 in FIG. 6, the coordinated vehicle drive control prohibiting unit 54 determines whether the battery voltage is larger than or equal to V3 and smaller than or equal to a threshold V4 (where V3<V2, V1<V4). When the battery voltage is larger than or equal to V3 and smaller than or equal to the threshold V4 (“Yes” in step S31), the process proceeds to step S33, whereas, when the battery voltage is not larger than or equal to V3 and smaller than or equal to the threshold V4 (“No” in step S31), the upper/lower limit processing unit 53 sets the alternator target driving force Fx_ac at 0 to prohibit the coordinated vehicle drive control (step S32).

In step S33, the charging driving force calculating unit 57 calculates a charging driving force Fx_dc (which is obtained by converting the amount of electric power generation used in PID control into a driving force) used in ND control on the basis of a deviation ΔV between the target battery voltage and the current battery voltage.

In step S34, the adding unit 55 adds the alternator target driving force Fx_ac and the charging driving force Fx_dc to calculate an ultimate alternator target driving force Fx_total, and outputs the calculated ultimate alternator target driving force Fx_total to the alternator control unit 34.

Thus, the alternator control unit 34 controls a field current that flows through the field coil of the alternator 20 on the basis of the ultimate alternator target driving force Fx_total to control a driving force (amount of electric power generation) of the alternator 20.

Note that in the present embodiment, the battery information for calculating the ultimate alternator target driving force Fx_total uses a battery voltage; an SOC may be used instead of the battery voltage.

As described above, according to the present embodiment, in the vehicle driving force control apparatus that controls a vehicle driving force by controlling the engine 10, which is a driving force generating source, and the alternator 20 that is driven by the engine 10 and that charges the battery 40, the ECU 30 includes the target driving force calculating unit 31 and the alternator target driving force correcting unit 33. The target driving force calculating unit 31 calculates the alternator target driving force Fx_ac when the alternator 20 is used for controlling a driving force of the vehicle. The alternator target driving force correcting unit 33 corrects the alternator target driving force Fx_ac determined by the target driving force calculating unit 31 by adding the charging driving force Fx_dc that is used when the alternator 20 charges the battery 40 with the target battery voltage to determine the ultimate alternator target driving force Fx_total. Thus, even when the alternator is used for vehicle drive control, the amount of electric power generation necessary for charging the battery with the target battery voltage may be ensured. Hence, it is possible to execute vehicle driving force control using the alternator while ensuring necessary electric power used in the vehicle.

In addition, according to the present embodiment, the alternator target driving force correcting unit 33 corrects the alternator target driving force Fx_ac, calculated by the target driving force calculating unit 31, on the basis of the battery voltage or SOC of the battery 40. Thus, it is possible to correct the alternator target driving force Fx_ac on the basis of the state of the battery and, therefore, it is possible to suppress fluctuations in voltage of the battery.

In addition, according to the present embodiment, when the driving force sign of the alternator target driving force Fx_ac calculated by the target driving force calculating unit 31 is positive and when the battery voltage or the SOC is low, the alternator target driving force correcting unit 33 multiplies the alternator target driving force Fx_ac by a control gain Gac smaller than that when the battery voltage or the SOC is high. Thus, because the amount of electric power generation is small when the driving force sign of the alternator target driving force Fx_ac is positive, the control gain Gac is decreased when the battery voltage or the SOC is low. This makes it possible to control a driving force of the vehicle while bringing the battery voltage within a desired range.

In addition, according to the present embodiment, when the driving force sign of the alternator target driving force Fx_ac calculated by the target driving force calculating unit 31 is negative, and when the battery voltage or the SOC is low, the alternator target driving force correcting unit 33 multiplies the alternator target driving force Fx_ac by a control gain Gac larger than that when the battery voltage or the SOC is high. Because the amount of electric power generation is large when the driving force sign of the alternator target driving force Fx_ac is negative, the control gain Gac is increased when the battery voltage or the SOC is low. This makes it possible to control a driving force of the vehicle while bringing the battery voltage within a desired range.

The driving force control apparatus for a vehicle and the driving force control method for a vehicle according to the aspects of the invention are advantageous when the alternator is used for controlling a driving force of the vehicle.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A driving force control apparatus for a vehicle, which controls a driving force of the vehicle by controlling a driving force generating source and an alternator that is driven by the driving force generating source and that charges a battery, comprising:
a target driving force calculating unit that calculates an alternator target driving force when the alternator is used for controlling the driving force of the vehicle; and
an alternator target driving force correcting unit that corrects the alternator target driving force, which is calculated by the target driving force calculating unit, using a charging driving force that is used when the alternator charges the battery with a target battery voltage to determine an ultimate alternator target driving force.

2. The driving force control apparatus according to claim 1, wherein
the alternator target driving force correcting unit corrects the alternator target driving force, which is calculated by the target driving force calculating unit, on the basis of a battery voltage or state of charge of the battery.

3. The driving force control apparatus according to claim 2, wherein
the alternator target driving force correcting unit corrects the alternator target driving force, which is calculated by the target driving force calculating unit, on the basis of a driving force sign of the alternator target driving force.

4. The driving force control apparatus according to claim 2, wherein
when a driving force sign of the alternator target driving force calculated by the target driving force calculating unit is positive and when the battery voltage or the state of charge is low, the alternator target driving force correcting unit multiplies the alternator target driving force by a control gain smaller than that when the battery voltage or the state of charge is high.

5. The driving force control apparatus according to claim 2, wherein
when a driving force sign of the alternator target driving force calculated by the target driving force calculating unit is negative and when the battery voltage or the state of charge is low, the alternator target driving force correcting unit multiplies the alternator target driving force by a control gain larger than that when the battery voltage or the state of charge is high.

6. The driving force control apparatus according to claim 2, wherein
the alternator target driving force correcting unit determines the ultimate alternator target driving force between a first threshold and a second threshold that is smaller than the first threshold.

7. The driving force control apparatus according to claim 6, wherein
when a driving force sign of the alternator target driving force calculated by the target driving force calculating unit is positive and when the battery voltage or the state of charge is closer to a second reference value corresponding to the second threshold than to a first reference value corresponding to the first threshold, the alternator target driving force correcting unit multiplies the alternator target driving force by a control gain smaller than that when the battery voltage or the state of charge is closer to the first reference value than to the second reference value.

8. The driving force control apparatus according to claim 6, wherein
when a driving force sign of the alternator target driving force calculated by the target driving force calculating unit is negative and when the battery voltage or the state of charge is closer to a second reference value corresponding to the second threshold than to a first reference value corresponding to the first threshold, the alternator target driving force correcting unit multiplies the alternator target driving force by a control gain larger than that when the battery voltage or the state of charge is closer to the first reference value than to the second reference value.

9. The driving force control apparatus according to claim 6, wherein
when a driving force sign of the alternator target driving force calculated by the target driving force calculating unit is both positive and negative or unknown and when the battery voltage or the state of charge is middle between a first reference value corresponding to the first threshold and a second reference value corresponding to the second threshold, the alternator target driving force correcting unit multiplies the alternator target driving force by a control gain larger than that when the battery voltage or the state of charge is close to the first reference value or to the second reference value.

10. A driving force control method for a vehicle, which controls a driving force of the vehicle by controlling a driving force generating source and an alternator that is driven by the driving force generating source and that charges a battery, comprising:
determining an alternator target driving force when the alternator is used for controlling the driving force of the vehicle; and
correcting the alternator target driving force using a charging driving force that is used when the alternator charges the battery with a target battery voltage to determine an ultimate alternator target driving force.
